(19) United States
(12) Patent Application Publication
(10) Pub. No.: US 2003/0044009 A1
(43) Pub. Date: Mar. 6, 2003

(54) System and method for secure communications with network printers

(76) Inventor: Sridhar Dathathraya, Cerritos, CA (US)

Correspondence Address: David C. Ripma, Patent Counsel, Patent Counsel, Sharp Laboratories of America, Inc., 5750 NW Pacific Rim Boulevard, Camas, WA, 98607, US

(21) Appl. No.: 09/944,695

(22) Filed: Aug. 31, 2001

(51) Int. Cl. H04L 9/00

(52) U.S. Cl. 380/55; 713/200

(57) ABSTRACT

A system and method are provided for secure communications to a network-connected printer. The method comprises: receiving documents encrypted with a public key; spooling the encrypted documents into a printer memory; accepting a private key corresponding to the public key used to encrypt the documents; in response to accepting the private key, generating a list of documents encrypted with a corresponding public key; creating a graphical user interface (GUI) dialog box to invoke the selection of an encrypted document; decrypting the documents with the private key; and, printing the decrypted documents in response to selecting a document. The printer has a card reader to read code from SMART cards, and accepting a private key includes using the code read by the card reader as the private key. Alternately, the printer has a keyboard interface to accept an alpha-numeric code. Then, the method further comprises: storing the private keys in the printer; creating a table in the printer to cross-reference private keys with alpha-numeric codes. Then, the private key referenced by the entered alpha-numeric code is used.

### BACKGROUND OF THE INVENTION

1. Field of the Invention

This invention generally relates to multifunction printing devices and, more particularly, to a system and method for adding security to the communications with a network-connected printing device.

2. Description of the Related Art

When a user wants to print confidential information using a networked printer, that user must take precautions that no one else is around the printer when the job is sent. Then, the user must hurry over to collect the printout before someone else goes to the printer, or before the confidential job is mixed up with someone else's job. Even if the user is situated near the printer, security can be foiled if the printer jams, so that the printing is delayed. Worse, the network can be slow or fail, causing the printing to be delayed, or leaving the user unsure of when, or if the ordered job will actually print. The user's security can also be compromised if they accidentally send the job to the wrong printer.

In addition, the data that is being sent to the printer can easily be captured at other network-connected computers or workstations using commercially available software programs. The document “spy” need only be connected to the network with an electromagnetic “sniffing” device. Then, the spy can capture confidential documents that a user originates or sends to a specific network address.

FIG. 1 is a schematic block diagram of a user printing a document to non-secure printer (prior art). The user is unable to see a crowd of people at the printer, or is unable to foresee other jobs arriving simultaneously with their job. A spy is also shown intercepting documents being sent to the printer.

It would be advantageous if print jobs to network printers could be made more secure from an unintended audience.

It would be advantageous if only the intended recipient of a print job could retrieve the printout at the printer.

It would be advantageous if network communications from a network-connected computer, or to a network-connected printer could avoid being captured.

### SUMMARY OF THE INVENTION

The present invention enables a user to print a job to a network printer using some known security features in a new context. The job remains spooled and encrypted at the printer until the user goes to the printer to trigger a hardcopy printout. The invention adds security to printing by encrypting the data, using the public key of the user, before the data is sent to the printer. Then, at the printer, the data is decrypted by reading the private key from the user's SMART identification card, using a smart card reader.

Accordingly, a method is provided for secure communications to a network-connected printer. The method comprises: receiving documents encrypted with a public key; spooling the encrypted documents into a printer memory; accepting a private key corresponding to the public key used to encrypt the documents; in response to accepting the private key, generating a list of documents encrypted with a corresponding public key; creating a graphical user interface (GUI) dialog box to invoke the selection of an encrypted document; decrypting the documents with the private key; and, printing the decrypted documents in response to selecting a document.

The printer has a card reader to read code from SMART cards, and accepting a private key includes using the code read by the card reader as the private key. Alternately, the printer has a keyboard interface to accept an alpha-numeric code. Then, the method further comprises: storing the private keys in the printer; creating a table in the printer to cross-reference private keys with alpha-numeric codes. Then, the private key referenced by the entered alpha-numeric code is used.

Further, the encrypted documents can be facsimile (FAX) transmissions, and the printer can be operated as a decrypting FAX machine. Additional details of the secure communication method and a secure communications printing device are presented below.

### BRIEF DESCRIPTION OF THE DRAWING

FIG. 1 is a schematic block diagram of a user printing a document to non-secure printer (prior art).

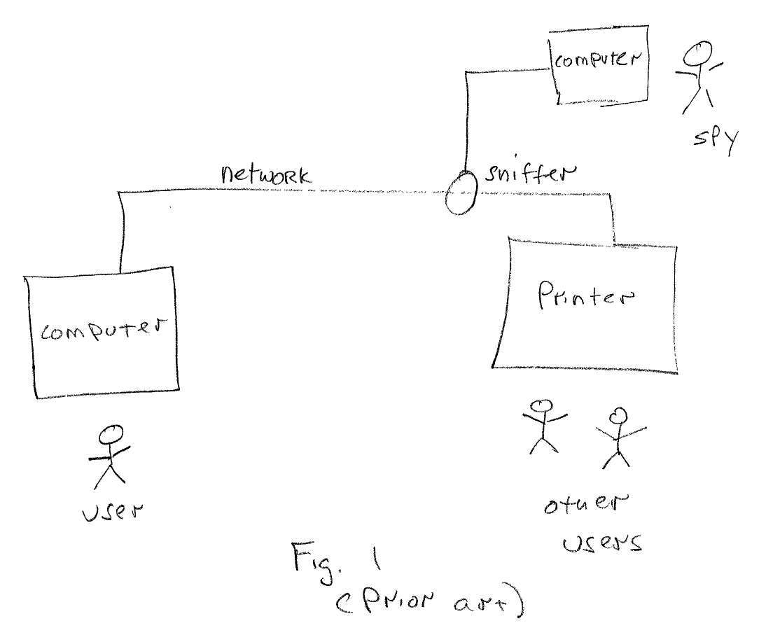

FIG. 2 is a schematic block diagram-of the-present invention communications security system in a network of connected devices.

FIG. 3 is a schematic block diagram of the first computer of FIG. 2.

FIG. 4 is a schematic block diagram of the first printer of FIG. 2.

FIG. 5 is a flowchart illustrating the present invention method for secure communications in a network of connected devices.

FIG. 6 is a flowchart illustrating the present invention method for secure communications to a network-connected printer.

### DETAILED DESCRIPTION OF THE PREFERRED EMBODIMENTS

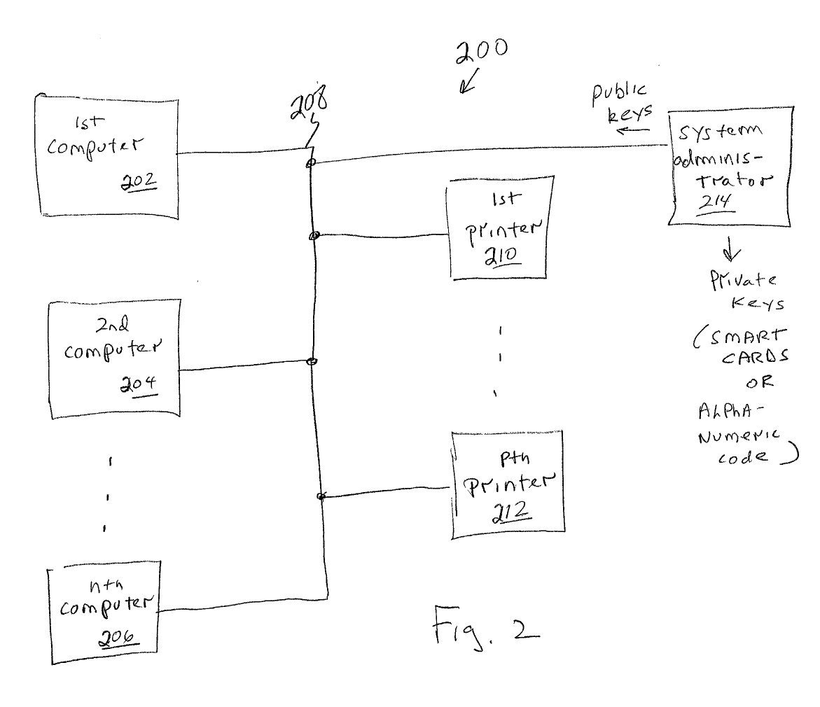

FIG. 2 is a schematic block diagram of the present invention communications security system in a network of connected devices. The system 200 comprises a first computer 202, a second computer 204, and an nth computer 206. Each of the computers 202-206 has a network connection on line 208. Line 208 represents a network, connected to the computers 202-206 to receive and transmit encrypted documents. There are a number of network types that can be used to connect computers and printers, for example, WAN or LAN networks. The present invention is not limited to any particular type of network. A first secure communications printer 210 and a pth secure communications printer 212 have inputs connected to the network 208 to accept encrypted documents.

A system administrator 214 generates a plurality of public keys with corresponding private keys. The system administrator distributes the public keys universally to network-connected computers, for example, via email, and selectively distributes the private keys. The system administrator can be situated in an organization's intranet, or as a third party connected via the Internet.

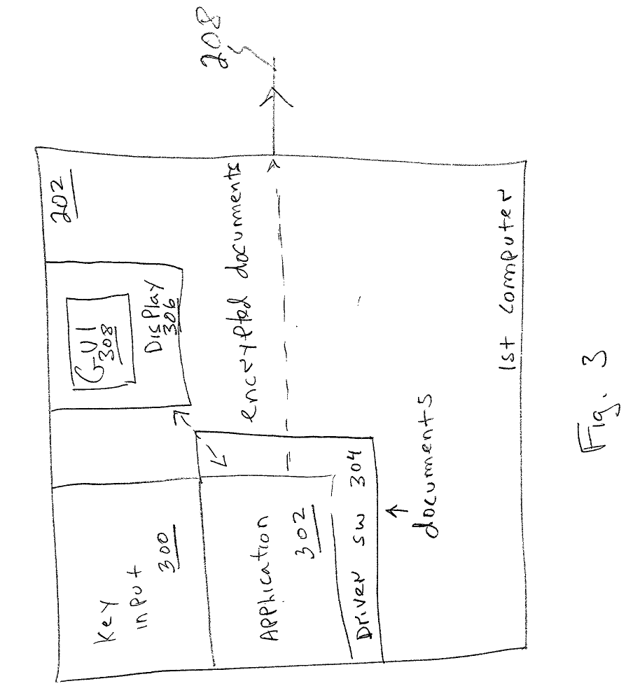

FIG. 3 is a schematic block diagram of the first computer 202 of FIG. 2. The first computer 202 is representative of the other computers (not shown in this figure). The computer 202 can also be referred to as a workstation terminal or user terminal. The first computer 202 has an input 300 to accept a public key. The first computer 202 includes an encryption application 302 to supply encrypted documents to the network connection 208, in response to accepting a public key. The computer includes printer driver encryption software 304 for generating the encryption application. Conventionally, the driver software 304 is loaded onto the computer for the purpose of formatting the documents into a form acceptable to the destination printer. In this particular application, the driver software 304 enables to computer to communicate encrypted documents to a destination printer capable of decrypting the documents.

The computer 202 has a display 306 with an input connected to the encryption application 302. The encryption application 302 creates a graphical user interface (GUI) dialog box 308 on the display 306 to optionally invoke the encryption of documents. In response to invoking the document encryption option, the GUI dialog box 308 requests and accepts public key information. The public keys can be maintained at a third party website, for example, maintained on a intranet system drive, or they can be downloaded via email from the system administrator.

It should be understood that the word “document” as used herein has its conventional meaning in most contexts. However, a document can also be any type of information that can be printed out. It should also be understood that the present invention is not limited to any particular type of public/private keying system. There are several public/private key systems in existence, such as the pretty good protection (PGP) and Rivest-Shamir-Alderman (RSA) systems, that can be used to enable the present invention. Generally, the keys are generated as pairs. The public keys are publicly distributed. A first user seeking to send a confidential message to a second user encrypts the message with the second user's public key. Once received, the second user decrypts the encrypted message using their private key. Thus, each private key has a corresponding public key.

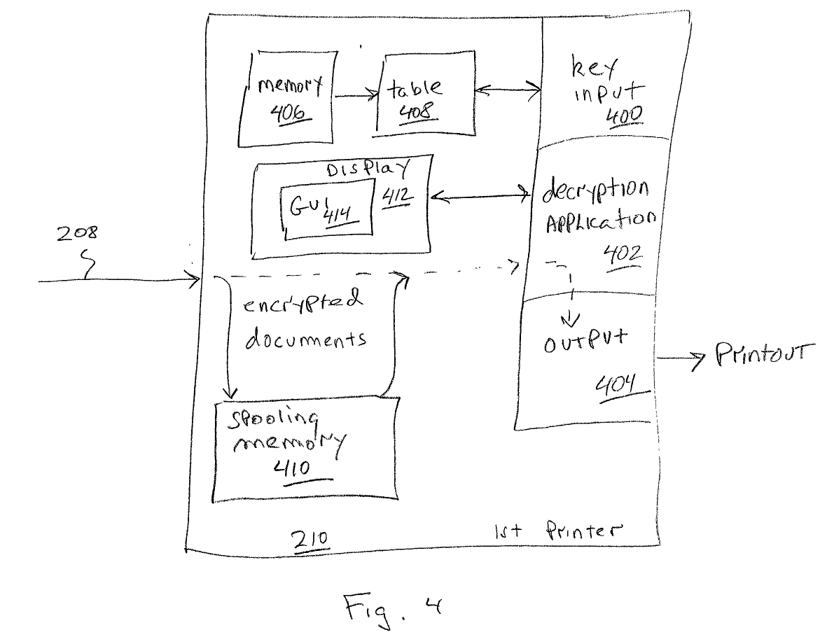

FIG. 4 is a schematic block diagram of the first printer 210 of FIG. 2. The first printer 210 is representative of the other printer (not shown). The printer 210 has an input 400 to accept a private key corresponding to the public key used to encrypt the documents at the computer. The printer 210 has a decryption application 402 to decrypt the documents with the private key, and an output 404 to supply a printout of the decrypted documents. The printer 210 is operated in response to the printer driver encryption software loaded in the computer (see FIG. 3).

In one aspect of the invention, the private keys are code configured in SMART cards. The system administrator distributes a SMART card, with the private key, to each user. As is well known, SMART cards include a microprocessor powered by the card reader, and have capacity to hold a relatively long (large number of bytes) lengths of code. Then, the printer key input 400 is a card reader to read SMART cards. The printer 210 uses the code read by the card reader 400 as the private key.

Alternately, the system administrator (see FIG. 2) generates a table cross-referencing the private keys to alpha-numeric codes, and selectively distributes the alpha-numeric codes. Then, the private key input 400 is a keyboard interface to accept an alpha-numeric code. The printer 210 has a memory 406 to store the private keys, and a table 408 to cross-reference private keys to alpha-numeric codes. The printer 210 accepts private keys referenced by the alpha-numeric code entered at the printer keyboard 400.

In some aspects of the invention, the printer 210 includes a memory 410 to spool the encrypted documents. The printer 210 decrypts the documents with the private key by retrieving the encrypted documents from printer memory 410.

Alternately, the system 200 further comprises a file server connected to the network to receive encrypted documents from the computer and to transmit encrypted documents to the printer. Returning briefly to FIG. 2, the file server could be enabled with the system administrator 214. In FIG. 4 the printer 210 decrypts documents with the private key after retrieving the encrypted documents from the file server on line 208.

In some aspects of the invention, the printer 210 has display 412 connected to the decryption application 402. In response to accepting a private key, the display depicts a list of documents encrypted with the corresponding public key. The decryption application 402 creates a GUI dialog box 414 on the display 412 to invoke the selection of encrypted documents. The printer prints the documents at output 404 in response to selecting a document from the GUI dialog box 414.

As defined herein, a printing device is a device that creates a hardcopy printout. The printing device may be a conventional printer, or a multifunctional printing (MFP) device that incorporates scanning and facsimile (FAX) functions. The printer can also be a single-function FAX device. Returning to FIG. 2, when the computer 202 transmits the encrypted documents as a facsimile (FAX) transmission, the network 208 is a telephone system, and the printer 210 decrypts the encrypted FAX transmission.

As mentioned above, in one application of the present invention, the printers have a SMART card reader installed. Users who want to use the security features of the printer are provided with a SMART card that holds their private key code. The system administrator typically generates the public and private keys for these users, and stores them in the email address book, or the printer itself can store this information. Alternately, a third party can issue and distribute the keys.

When a user desires print security, the encrypt option is enabled in the print settings dialog box provided by the print driver. The print driver then uses the user's public key from the stored location to encrypt the data (document) before sending it to the printer. The print engine (printer), when it sees that the job is encrypted, simply spools the data on to storage in the printer, or to a storage location such as a network drive or file server. The user walks up to the printer and inserts their SMART card in the slot on the printer. The printer identifies the user and displays a list of jobs for that user on the printer display panel. Using the touch screen capabilities of the printers display panel, or an equivalent GUI mechanism, the printing is started. The printer uses the private key from the card to decrypt the encrypted document.

Instead of using a SMART card to identify a user, alternate embodiments of the invention use a display panel on the printer as an input device for entering the password information about the user. For example, a user's PIN number. Then, the code can be cross-referenced to a private key stored in the printer.

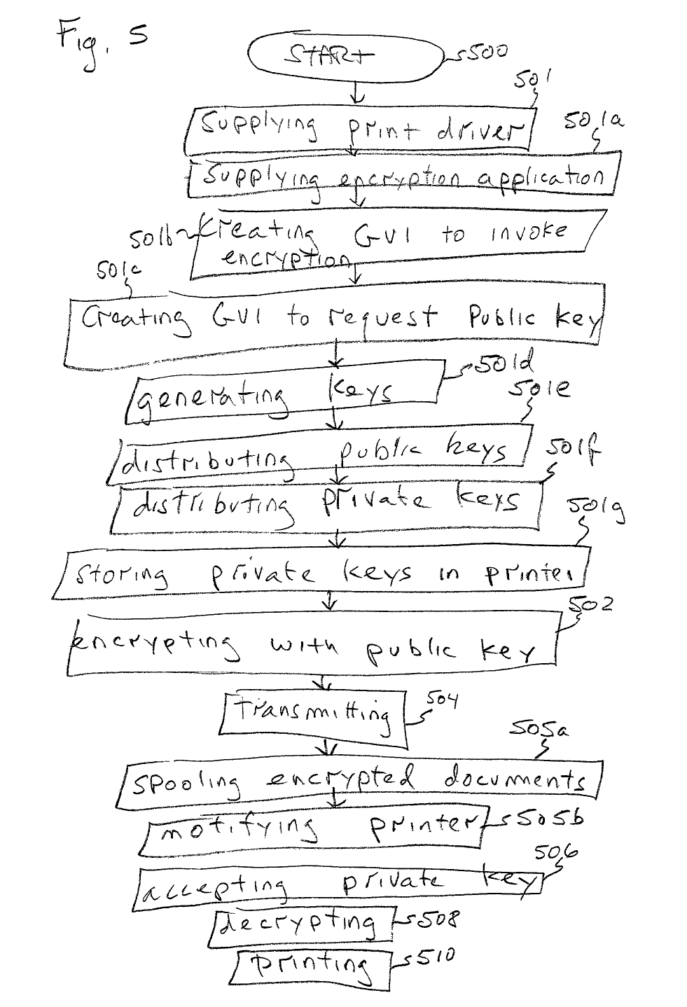

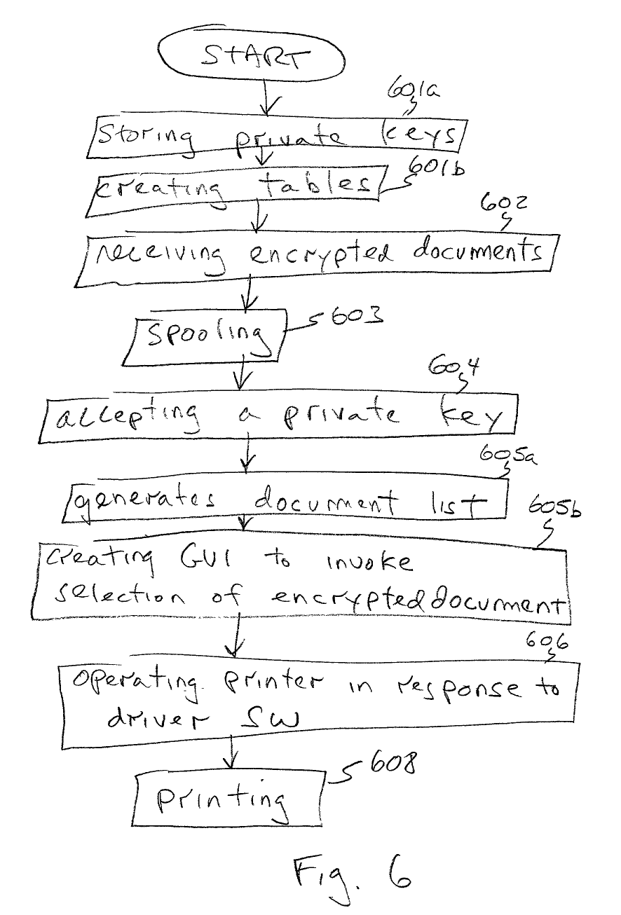

FIG. 5 is a flowchart illustrating the present invention method for secure communications in a network of connected devices. Although the method (and the method depicted by FIG. 6 below) is depicted as a sequence of numbered steps for clarity, no order should be inferred from the numbering unless explicitly stated. The method starts at Step 500. Step 502 encrypts documents with a public key. Step 504 transmits the encrypted documents to a network-connected printer. Step 506, at the printer, accepts a private key corresponding to the public key used to encrypt the documents. Step 508 decrypts the documents with the private key. Step 510 prints the decrypted documents.

Encrypting the documents with a public key in Step 502 includes encrypting the documents at a network-connected computer having a public key encryption application. Then, transmitting the encrypted documents to a network-connected printer in Step 504 includes transmitting the encrypted documents from the computer, to the printer, through a network.

In some aspects of the invention a further step, Step 501, supplies printer driver encryption software to the computer. Decrypting the documents with the private key in Step 508 includes operating the printer in response to the printer driver encryption software. Supplying the printer driver encryption software to the computer in Step 501 includes substeps. Step 501 a supplies an application to optionally encrypt documents. Step 501b, in response to the application, creates a graphical user interface (GUI) dialog box to invoke the document encryption option. Step 501c, in response to invoking the document encryption option, creates a GUI dialog box to request and accept public key information.

Step 501d generates a plurality of public keys with corresponding private keys. Step 501e distributes the public keys universally to network-connected computers. In some aspects, the universe is limited to a defined users group or organization. Step 501f selectively distributes the private keys, generally one private key per user.

In some aspects of the invention, the printer has a card reader to read code from SMART cards. Then, selectively distributing the private keys in Step 501f includes distributing the private keys as SMART cards. Accepting a private key in Step 506 includes using the code read by the printer card reader.

Alternately, the printer has a keyboard interface to accept an alpha-numeric code, and the method comprises further steps. Step 501g stores the private keys in the printer, and selectively distributing the private keys in Step 501f includes substeps. Step 501f1 (not shown) selectively distributes alpha-numeric codes. Step 501f2 (not shown) creates a table in the printer to cross-reference private keys with alpha-numeric codes. Accepting the private keys in Step 506 includes using the private key referenced by the entered alpha-numeric code.

In some aspects, a further step, Step 505a, spools the encrypted documents in printer memory. Decrypting the documents with the private key in Step 508 includes retrieving the encrypted documents from printer memory. Alternately, Step 505a spools the encrypted documents to a network-connected file server. Step 501b notifies the printer of encrypted documents spooled on the network file server. Decrypting the documents with the private key in Step 508 includes the printer retrieving the encrypted documents from the file server.

Some aspects of the invention-include further steps. Step 507a (not shown), in response to accepting the private key, generates a list of documents encrypted with the corresponding public key. Step 507b (not shown) creates a graphical user interface (GUI) dialog box to invoke the selection of an encrypted document. Then, printing the documents in Step 510 includes printing the documents in response to selecting a document in Step 507b.

In some aspects of the invention, transmitting the encrypted documents to a network-connected printer in Step 504 includes transmitting a facsimile (FAX) transmission. Then, decrypting the documents with the private key in Step 508 includes decrypting the encrypted FAX transmissions.

FIG. 6 is a flowchart illustrating the present invention method for secure communications to a network-connected printer. The method starts at Step 600. Step 602 receives documents encrypted with a public key. Step 604 accepts a private key corresponding to the public key used to encrypt the documents. Step 606 decrypts the documents with the private key. Decrypting the documents with the private key in Step 606 includes operating the printer in response to publicly distributed printer driver encryption software. Step 608 prints the decrypted documents.

In some aspects of the invention, the printer has a card reader to read code from SMART cards, and accepting a private key in Step 604 includes using the code read by the printer card reader as the private key. Alternately, the printer has a keyboard interface to accept an alpha-numeric code, and the method comprises further steps. Step 601a stores the private keys in the printer. Step 601b creates a table in the printer to cross-reference private keys with alpha-numeric codes. Then, accepting the private keys in Step 604 includes using the private key referenced by the entered alpha-numeric code as the private key.

In some aspects, a further step, Step 603 spools the encrypted documents into a printer memory, and decrypting the documents with the private key in Step 606 includes retrieving the encrypted documents from printer memory.

In some aspects of the invention, Step 605a, in response to accepting the private key, generates a list of documents encrypted with a corresponding public key. Step 605b creates a graphical user interface (GUI) dialog box to invoke the selection of an encrypted document. Printing the documents in Step 608 includes printing the documents in response to selecting a document.

When receiving documents encrypted with a public key (Step 602) includes receiving encrypted documents transmitted as a facsimile (FAX) transmission, then decrypting the document with a private key in Step 606 includes decrypting the encrypted FAX transmissions.

A system and method have been provided for making communications secure to a network-connected printer. Examples have been given of protecting printing and FAX transmission jobs, however, the present invention is not limited to just these applications. Public/private key sets have been described as the security means. However, other variations and embodiments of the invention will occur to those skilled in the art.

We claim:

1. In a network of connected devices, a communications security method comprising:
encrypting documents with a public key;
transmitting the encrypted documents to a network-connected printer;
at the printer, accepting a private key corresponding to the public key used to encrypt the documents;
decrypting the documents with the private key; and,
printing the decrypted documents.

2. The method of claim 1 wherein encrypting the documents with a public key includes encrypting the documents at a network-connected computer having a public key encryption application; and,
wherein transmitting the encrypted documents to a network-connected printer includes transmitting the encrypted documents from the computer, to the printer, through a network.

3. The method of claim 2 wherein decrypting the documents with the private key includes operating the printer in response to the printer driver encryption software; and
the method further comprising:
supplying the printer driver encryption software to the computer.

4. The method of claim 3 wherein supplying the printer driver encryption software to the computer includes:
supplying an application to optionally encrypt documents;
in response to the application, creating a graphical user interface (GUI) dialog box to invoke the document encryption option; and,
in response to invoking the document encryption option, creating a graphical user interface (GUI) dialog box to request and accept public key information.

5. The method of claim 2 further comprising:
generating a plurality of public keys with corresponding private keys;
distributing the public keys universally to network-connected computers; and,
selectively distributing the private keys.

6. The method of claim 5 in which the printer has a card reader to read code from SMART cards;
wherein selectively distributing the private keys includes distributing the private keys as SMART cards; and,
wherein accepting a private key includes using the code read by the printer card reader.

7. The method of claim 5 in which the printer has a keyboard interface to accept an alpha-numeric code, and the method further comprising:
storing the private keys in the printer;
wherein selectively distributing the private keys includes:
selectively distributing alpha-numeric codes;
creating a table in the printer to cross-reference private keys with alpha-numeric codes; and,
wherein accepting the private keys includes using the private key referenced by the entered alpha-numeric code.

8. The method of claim 2 further comprising:
spooling the encrypted documents in printer memory; and,
wherein decrypting the documents with the private key includes retrieving the encrypted documents from printer memory.

9. The method of claim 2 further comprising:
spooling the encrypted documents to a network-connected file server;
notifying the printer of encrypted documents spooled on the network file server; and,
wherein decrypting the documents with the private key includes the printer retrieving the encrypted documents from the file server.

10. The method of claim 2 further comprising:
in response to accepting the private key, generating a list of documents encrypted with the corresponding public key;
creating a graphical user interface (GUI) dialog box to invoke the selection of an encrypted document; and,
wherein printing the documents includes printing the documents in response to selecting a document.

11. The method of claim 1 wherein transmitting the encrypted documents to a network-connected printer includes transmitting a facsimile (FAX) transmission; and,
wherein decrypting the documents with the private key includes decrypting the encrypted FAX transmission.

12. A method for secure communications to a network-connected printer, the method comprising:
receiving documents encrypted with a public key;
accepting a private key corresponding to the public key used to encrypt the documents;
decrypting the documents with the private key; and,
printing the decrypted documents.

13. The method of claim 12 wherein decrypting the documents with the private key includes operating the printer in response to publicly distributed printer driver encryption software.

14. The method of claim 12 in which the printer has a card reader to read code from SMART cards; and,
wherein accepting a private key includes using the code read by the printer card reader as the private key.

15. The method of claim 12 in which the printer has a keyboard interface to accept an alpha-numeric code, and the method further comprising:
storing the private keys in the printer;
creating a table in the printer to cross-reference private keys with alpha-numeric codes; and,
wherein accepting the private keys includes using the private key referenced by the entered alpha-numeric code as the private key.

16. The method of claim 12 further comprising:
spooling the encrypted documents into a printer memory; and,
wherein decrypting the documents with the private key includes retrieving the encrypted documents from printer memory.

17. The method of claim 12 further comprising:
in response to accepting the private key, generating a list of documents encrypted with a corresponding public key;
creating a graphical user interface (GUI) dialog box to invoke the selection of an encrypted document; and,
wherein printing the documents includes printing the documents in response to selecting a document.

18. The method of claim 12 wherein receiving documents encrypted with a public key includes receiving encrypted documents transmitted as a facsimile (FAX) transmission; and,
wherein decrypting the documents with the private key includes decrypting the encrypted FAX transmission.

19. A communications security system in a network of connected devices, the system comprising:
a computer having a network connection, an input to accept a public key, and an encryption application to supply encrypted documents to the network connection in response to accepting a public key;
a network connected to the computer to receive and transmit encrypted documents; and,
a printer having an input connected to the network to accept encrypted documents, the printer having an input to accept a private key corresponding to the public key used to encrypt the documents at the computer, the printer having a decryption application to decrypt the documents with the private key, and the printer having an output to supply a printout of the decrypted documents.

20. The system of claim 19 wherein the computer - includes printer driver encryption software to generate the encryption application; and
wherein the printer is operated in response to the printer driver encryptions software loaded in the computer.

21. The system of claim 20 wherein the computer has a display with an input connected to the application, wherein encryption application creates a graphical user interface (GUI) dialog box on the display to optionally invoke the encryption of documents, and in response to invoking the document encryption option, creates a GUI dialog box to request and accept public key information.

22. The system of claim 19 further comprising:
a system administrator to generate a plurality of public keys with corresponding private keys, the system administrator distributing the public keys universally to network-connected computers, and selectively distributing the private keys.

23. The system of claim 22 further comprising:
private keys configured code in SMART cards; and,
wherein the printer private key input is a card reader to read SMART cards, the printer using the code read by the card reader as the private key.

24. The system of claim 22 wherein the system administrator generates a table cross-referencing the private keys to alpha-numeric codes, and selectively distributes the alpha-numeric codes; and,
wherein the printer private key input is a keyboard interface to accept private keys referenced by the alpha-numeric code entered on the keyboard, and the printer further comprising a memory to store the private keys, and a table to cross-reference private keys to alpha-numeric codes.

25. The system of claim 19 wherein the printer includes a memory to spool the encrypted documents, the printer decrypting the documents with the private key by retrieving the encrypted documents from printer memory.

26. The system of claim 19 further comprising:
a file server connected to the network to receive encrypted documents from the computer and to transmit encrypted documents to the printer; and,
wherein the printer decrypts documents with the private key after retrieving the encrypted documents from the file server.

27. The system of claim 19 wherein the printer has display connected to the decryption application to depict a list of documents encrypted with a corresponding public key, in response to accepting the private key;
wherein the printer decryption application creates a GUI dialog box on the display to invoke the selection of encrypted documents, the printer printing the documents in response to selecting a document from the GUI dialog box.

28. The system of claim 19 wherein the computer transmits the encrypted documents as a facsimile (FAX) transmission;
wherein the network is a telephone system; and,
wherein the printer decrypts the encrypted FAX transmission.

29. A secure communications network-connected printer, the printer comprising:
a network connection to receive documents encrypted with a public key;
an input to accept a private key corresponding to the public key used to encrypt the documents;
an decryption application to decrypt the documents with the private key; and,
an output to supply a printout of the decrypted documents.

30. The printer of claim 29 wherein the decryption application is responsive to publicly distributed printer driver encryption software.

31. The printer of claim 29 wherein the private key input is a card reader to read code from SMART cards.

32. The printer of claim 29 wherein the private key input is a keyboard interface to accept an alpha-numeric code; and,
the printer further comprising:
a memory to store the private keys;
a memory to store a table cross-referencing private keys with alpha-numeric codes; and,
wherein private key input uses the private key referenced by the alpha-numeric code entered at the printer keyboard.

33. The printer of claim 29 further comprising:
a memory to spool the encrypted documents; and,
wherein decryption application retrieves the encrypted documents from printer memory for decryption.

34. The printer of claim 29 further comprising:
a display having an input;
wherein the decryption application creates a graphical user interface (GUI) dialog box application on the display to invoke the selection of an encrypted document, the GUI generating a list of documents encrypted with a corresponding public key, in response to accepting the private key; and,
wherein the documents are decrypted and printed in response to the documents being selected from the GUI.

35. The system of claim 29 wherein the network connection is a telephone connection and the encrypted documents are facsimile (FAX) transmissions; and,
wherein the printer decrypts the encrypted FAX transmission.
